(19) United States
(12) Patent Application Publication
(10) Pub. No.: US 2014/0232682 A1
(43) Pub. Date: Aug. 21, 2014

(54) Apparatus and Method for Detecting Contact

(71) Applicant: Jae Hong Kim, Seoul (KR)

(72) Inventor: Jae Hong Kim, Seoul (KR)

(73) Assignee: MELFAS INC., Seongnam-si, Gyeonggi-do (KR)

(21) Appl. No.: 14/009,055

(22) PCT Filed: Nov. 22, 2011
(86) PCT No.: PCT/KR11/08900

§ 371 Date: Sep. 30, 2013

(30) Foreign Application Priority Data
Apr. 1, 2011 (KR) 10-2011-0030306

(51) Int. Cl. G06F 3/044

(52) U.S. Cl. CPC G06F 3/044; G06F 2203/04104
USPC 345/174

(57) ABSTRACT

An apparatus for detecting contact, according to the present invention, comprises: a substrate; a plurality of first electrodes which are formed on the substrate; a plurality of second electrodes which are formed on the substrate; and a controller chip for receiving applied signals from the plurality of first electrodes and the plurality of second electrodes, and determining a contact input, wherein the controller chip eliminates a value of a predetermined proportion of values from each of the signals.

### TECHNICAL FIELD

The present invention relates to an apparatus and method for sensing a touch, and more particularly, to a single-layer touch sensing apparatus and method that may determine one or more touch inputs sequentially acquired.

### BACKGROUND ART

With the wide distribution of mobile phones equipped with touch screens, and with the increasing popularity of various types of smartphones, research on touch sensing technology is being actively conducted.

Touch screens, which are typical touch sensing apparatuses, may be classified into resistive touch screens, capacitance touch screens, ultrasound touch screens, infrared (IR) touch screens, and the like, based on operation methods of the touch screens. Here, the capacitance touch screens have relatively excellent durability and lifespan and may support a multi-touch function and thus, have been currently employed in various application fields.

Capacitance touch screens may be classified based on a method of determining a touch input using self-capacitance generated between a touch object and a sensing electrode and a method of applying a predetermined driving signal and determining a touch input using mutual-capacitance generated between a plurality of sensing electrodes by a touch object.

A method of using self-capacitance may simplify a circuit configuration and easily construct a capacitance touch screen, but may have difficulty in determining multiple touches.

A method of using mutual-capacitance may easily determine multiple touches compared to the method of using self-capacitance. However, since a capacitance touch screen needs to be constructed in a 2-layer structure, a thickness of the capacitance touch screen may increase.

In general, in the case of an electrode pattern of a 2-layer touch screen, a lozenge shaped electrode connected in a predetermined direction may be formed using a transparent conductive material, for example, indium tin oxide (ITO). A plurality of electrodes connected on a second axis may be connected to a plurality of sensing channels on a first axis. A plurality of electrodes connected on the first axis may be connected to a plurality of sensing channels on the second axis.

For example, when the first axis is an X axis and the second axis is an Y axis, sensing signals acquired from the plurality of sensing channels in an X-axial direction may be used to determine an X coordinate of a touch location and sensing signals acquired from the plurality of sensing channels in a Y-axial direction may be used to determine an Y coordinate.

However, in determining two locations, for example, an X coordinate location and an Y coordinate location, it may be difficult to verify accurate two touch locations from among combinations of X coordinates and Y coordinates due to a ghost phenomenon and the like.

For example, even though a user touches two points, (X3, Y3) corresponding to a third location on the X axis and a third location on the Y axis and (X6, Y5) corresponding to a sixth location on the X axis and a fifth location on the Y axis, the touch points may be erroneously recognized as tow points (X6, Y3) corresponding to the sixth location on the X axis and the third location on the Y axis and (X3, Y5) corresponding to the third location on the X axis and the fifth location on the Y axis due to the ghost phenomenon and the like.

To overcome such ghost phenomenon, a 2-layer mutual-capacitance method of combining XN electrodes and YM electrodes, for example, sequentially driving or exciting each X electrode and sensing a change in a signal acquired from each Y electrode may be employed. However, the 2-layer mutual capacitance method may increase a thickness of a touch screen.

### DESCRIPTION OF THE INVENTION

### Technical Objects

An embodiment of the present invention provides an apparatus and method for sensing a touch that may accurately determine a plurality of touch inputs using a single-layer structure.

Another embodiment of the present invention also provides an apparatus and method for sensing a touch that may configure a ghost-phenomenon-free multi-touch function by applying a mutual capacitance method to a single-layer touch sensing apparatus.

### Technical Solutions

According to an aspect of the present invention, there is provided an apparatus for sensing a touch, including: a substrate; a plurality of first electrodes formed on the substrate; a plurality of second electrodes formed on the substrate; and a controller chip configured to acquire signals from the plurality of first electrodes and the plurality of second electrodes, and to determine a touch input. The controller chip may subtract a value of a predetermined rate of each signal value from another signal value.

The plurality of first electrodes and the plurality of second electrodes may be disposed on the same surface of the substrate.

The plurality of first electrodes may be sensing electrodes and the plurality of second electrodes may be driving electrodes electrically separate from the plurality of first electrodes.

The controller chip may subtract the value of the predetermined rate of each signal from another signal value of a subsequent order based on orders in which the signals are acquired from the plurality of second electrodes.

Each of the plurality of first electrodes may be disposed in a shape of a sensing bar that is extended along a first axis, and each of the plurality of second electrodes may be disposed on a second axis that intersects the first axis.

According to another aspect of the present invention, there is provided a method of sensing a touch, the method including: acquiring signals from a plurality of first electrodes and a plurality of second electrodes formed on one surface of a substrate; and determining a touch input based on the signals. The determining of the touch input may include subtracting a value of a predetermined rate of each signal value from another signal value of a subsequent order based on orders in which the signals are acquired.

The determining of the touch input may further include subtracting the value of the predetermined rate of each signal value from the other signal value of the subsequent order based on orders in which the signals are acquired from the plurality of second electrodes.

### Effects of the Invention

According to embodiments of the present invention, it is possible to accurately determine a plurality of touch inputs using a single-layer structure.

According to embodiments of the present invention, it is possible to configure a ghost-phenomenon-free multi-touch function by applying a mutual capacitance method to a single-layer touch sensing apparatus.

### BRIEF DESCRIPTION OF THE INVENTION

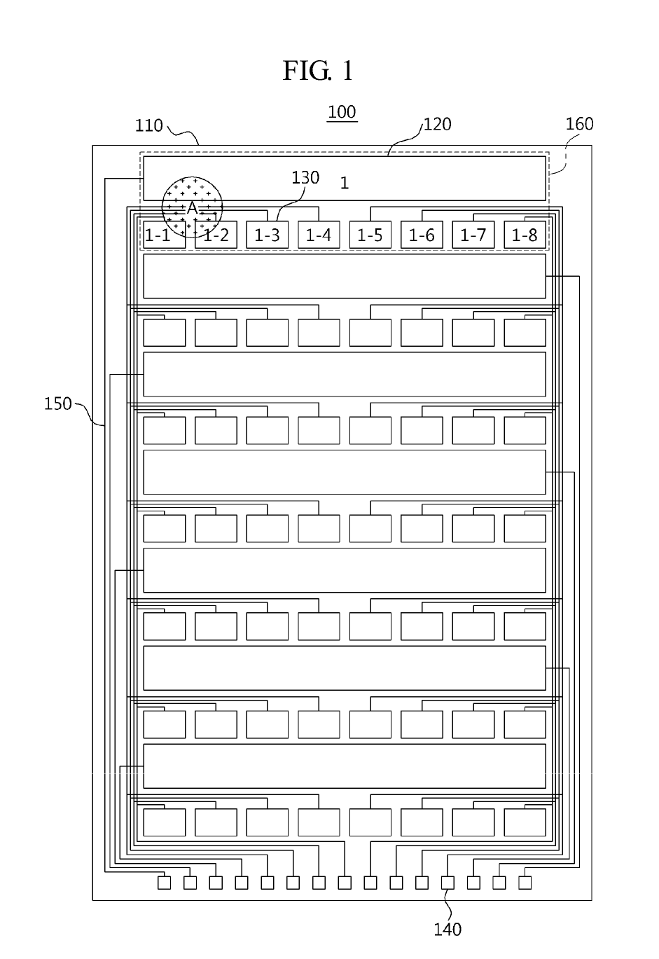

FIG. 1 is a diagram illustrating a configuration of a touch sensing apparatus according to an embodiment of the present invention.

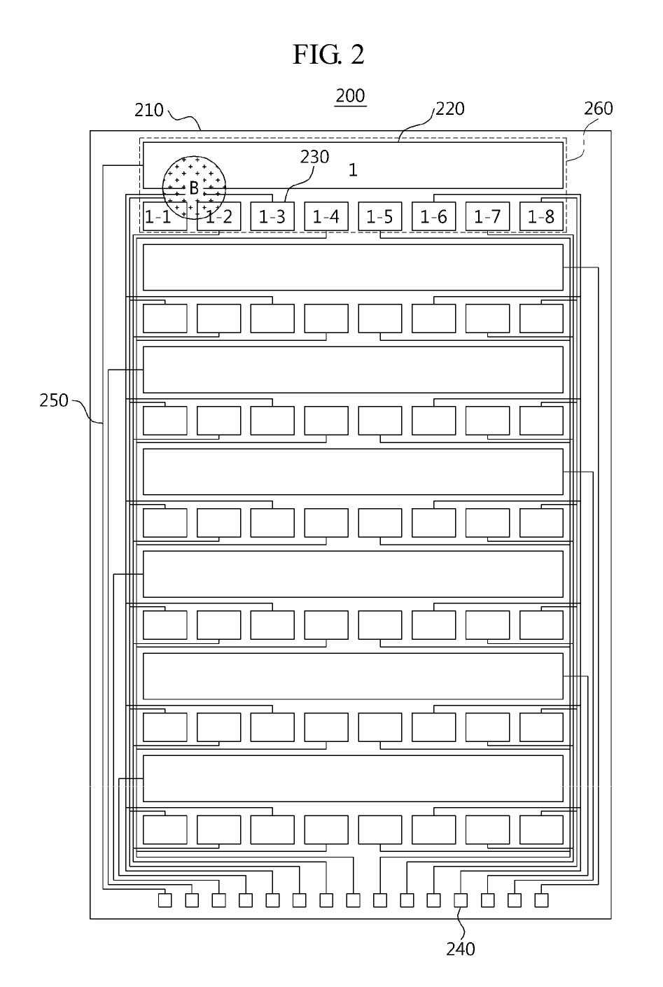

FIG. 2 is a diagram illustrating a configuration of a touch sensing apparatus according to another embodiment of the present invention.

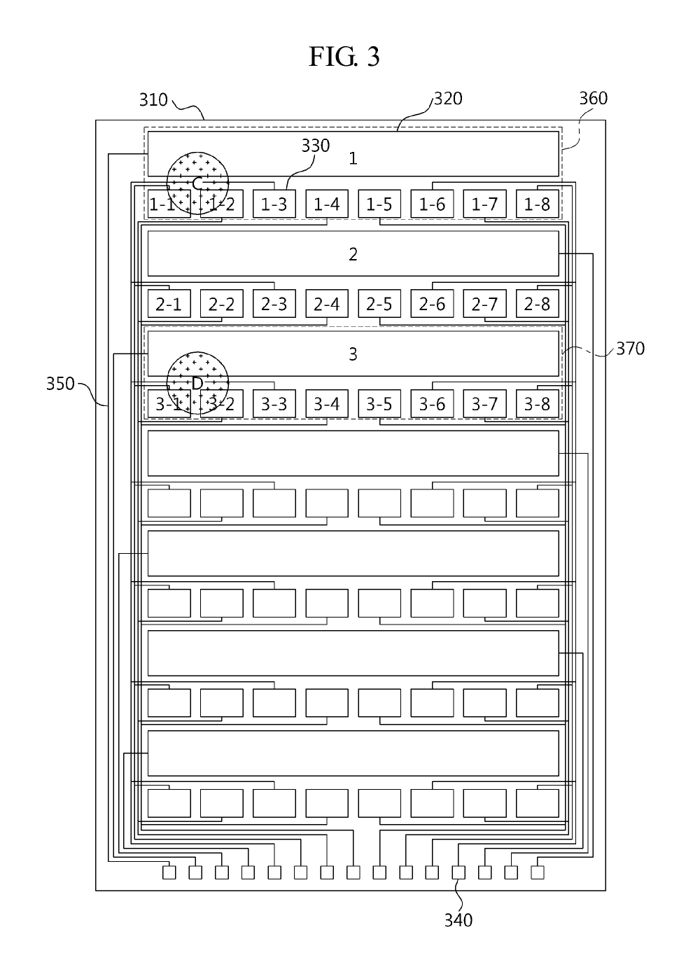

FIG. 3 is a diagram illustrating an example of recognizing multiple touches using a touch sensing apparatus according to still another embodiment of the present invention.

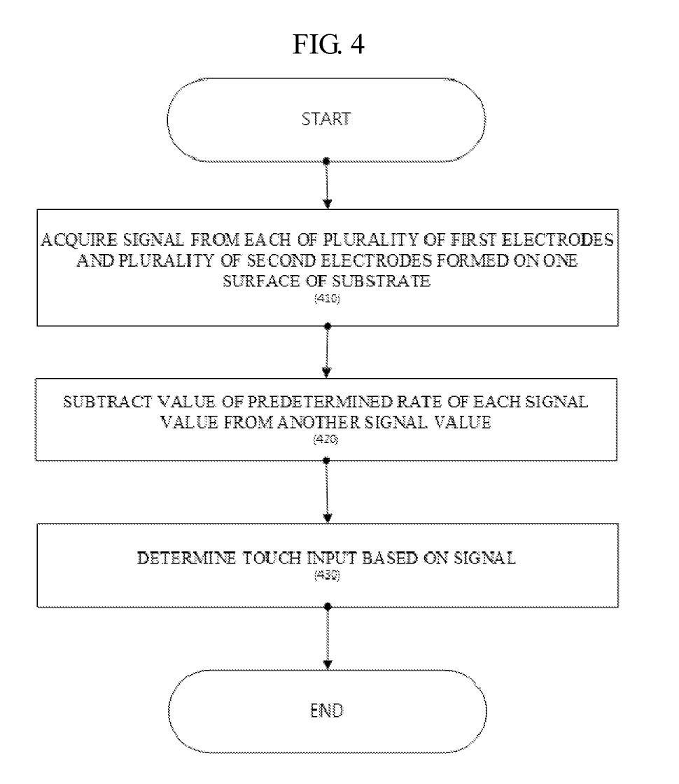

FIG. 4 is a flowchart illustrating a touch sensing method according to an embodiment of the present invention.

### BEST MODE FOR CARRYING OUT THE INVENTION

Hereinafter, embodiments of the present invention will be described with reference to the accompanying drawings and contents included therein, however the present invention is not limited thereto or restricted thereby.

When it is determined detailed description related to a related known function or configuration they may make the purpose of the present invention unnecessarily ambiguous in describing the present invention, the detailed description will be omitted here. Also, terminologies used herein are defined to appropriately describe the embodiments of the present invention and thus may be changed depending on a user, the intent of an operator, or a custom. Accordingly, the terminologies must be defined based on the following overall description of this specification.

FIG. 1 is a diagram illustrating a configuration of a touch sensing apparatus according to an embodiment of the present invention.

Referring to FIG. 1, a touch sensing apparatus 100 according to an embodiment of the present invention may include a substrate 110, a plurality of first electrodes 120 formed on the substrate 110, a plurality of second electrodes 130 formed on the substrate 110, and a controller chip 140 configured to acquire signals from the plurality of first electrodes 120 and the plurality of second electrodes 130 and to determine a touch input.

According to an aspect of the present invention, the controller chip 140 may determine the touch input based on a change in mutual capacitance generated between the plurality of first electrodes 120 and the plurality of second electrodes 130.

The first electrode 120 may be assumed as a sensing electrode configured to sense a sensing signal, and the second electrode 130 may be assumed as a driving electrode electrically separate from the first electrode 120.

The controller chip 140 of FIG. 1 may determine the touch input by applying signals to at least a portion of the plurality of second electrodes 130, and by acquiring the signals from the plurality of first electrodes 120.

The controller chip 140 of the present invention may subtract a value of a predetermined rate v of each signal value from another signal value.

The touch sensing apparatus 100 may include a wiring pattern 150 disposed on each of left and right bezel regions of the substrate 110 to thereby be electrically connected to the plurality of first electrodes 120 and the plurality of second electrodes 130. The wiring pattern 150 may include a bonding pad (not shown) extended up to one end of the substrate 110 to be electrically connected to a circuit substrate (not shown) on which the controller chip 140 is mounted.

The substrate 110 refers to a support plate on which the plurality of first electrodes 120, the plurality of second electrodes 130, the wiring pattern 150, the bonding pad, and the like, are disposed and on which the controller chip 140 is mounted through an anisotropic conductive film (ACF) process and the like, and may be prepared using a material such as polyethylene terephthalate (PET), polymethyl methacrylate (PMMA), propylene carbonate (PC), polyimide (PI), a tempered glass, a sapphire glass, and the like.

In the case of a touch screen attached to a display device, the touch sensing apparatus 100 may use a material having an excellent transmissivity, such as the aforementioned material.

The plurality of first electrodes 120 and the plurality of second electrodes 130 may be disposed on the same surface of the substrate 110 to thereby constitute a single-layer structure of the touch sensing apparatus.

The plurality of second electrodes 130 may be disposed on the substrate to be in a patch form.

The substrate 110 may be provided as a transparent window. The plurality of first electrodes 120, the plurality of second electrodes 130, and the wiring pattern 150 may be integrally formed with the transparent window.

Each of the plurality of first electrodes 120 may be disposed in a shape of a sensing bar that is extended along a first axis, and each of the plurality of second electrodes 130 may be disposed on a second axis that intersects the first axis.

Also, at least a portion of the plurality of second electrodes 130 may be electrically connected to another plurality of second electrodes 130 disposed on the same second axis.

Among the plurality of second electrodes 130, electrodes disposed on the same second axis may be electrically connected to each other through the wiring pattern 150.

Referring to FIG. 1, the first axis corresponds to a horizontal direction, that is, an X-axial direction and the second axis corresponds to a vertical direction, that is, an Y-axial direction. A single sensing area 160 including a single first electrode 120 and eight second electrodes 130 may be formed. A total of seven sensing areas 160 may be included in the entire touch sensing panel 100.

A sensing region of the present invention is not limited to an inclusion relationship between the plurality of first electrodes 120 and the plurality of second electrodes 130 and thus, may be implemented in various forms.

For example, a single second electrode 130 and a partial area of the first electrode disposed to be adjacent thereto may be verified as a single sensing region. In this example, a total of 56 sensing regions 160 may be included in the entire touch sensing apparatus 100, which is different from the aforementioned example.

The term ‘sensing region’ used throughout the present specification needs to be understood as a predetermined unit region on which a touch input of a user can be determined, instead of being understood as a region defined by a physically or electrically separate sensing electrode or a sensing channel connected to the controller chip 140.

Each of the plurality of first electrodes 120 and the plurality of second electrodes 130 may be electrically connected to the controller chip 140 through the wiring pattern 150 disposed on each of the left and right bezel regions of the substrate 110.

The number of wiring patterns 150 and a width of a bezel region according thereto may be reduced by connecting at least a portion of the plurality of second electrodes 130 disposed on the same second axis to a single wiring pattern 150.

As illustrated in FIG. 1, the wiring patterns 150 may be symmetrically disposed on the second axis that passes through each center of the plurality of first electrodes 120 extended from the first axis. According to the above arrangement type, the number of times that a recursive algorithm is applied and a direction in which the recursive algorithm is applied may be defined. An example of applying the recursive algorithm will be described below.

The wiring pattern 150, disposed on a valid display region of the touch sensing apparatus 100 to be attached to a display device of the present invention, may be formed using a transparent conductive material, such as ITO, ZnO, IZO, and CNT, for example.

In the touch sensing apparatus 100, a plurality of ground wirings (not shown) may be formed along the first axis on the substrate 110 on/below the plurality of first electrodes 120.

The plurality of ground wirings may be spaced apart from the plurality of first electrodes 120 to thereby be electrically insulated from each other and be electrically connected to a ground of the substrate 110.

In a case in which the plurality of ground wirings is formed on the substrate 110 on/below the plurality of first electrodes 120, it is possible to decrease capacitance occurring between the plurality of first electrodes 120 and the plurality of second electrodes 130. Accordingly, it is possible to additionally eliminate a noise component according to a touch input.

The plurality of second electrodes 130 disposed on the same second axis may be electrically connected to each other through the wiring pattern 150, and each of the second electrodes 130 may sequentially apply a signal.

Hereinafter, for understanding of the present invention, a description will be made based on the assumption that the first electrode 120 is a sensing electrode, the second electrode 130 is a driving electrode, and the second electrodes 130 of FIG. 1 are driving electrodes 1-1 through driving electrode 1-8 starting from the left.

Referring to FIG. 1, in a case in which signals are acquired from the driving electrodes 1-2 through 1-7, each of the signals may be transferred through a wiring that is disposed to be very close to the first electrode 120. Accordingly, a mutual-capacitance recognition phenomenon may occur between the first electrode 120 and the wiring pattern 150 through which a signal is transferred and thus, a signal acquired through the wiring pattern 150 may act as a noise signal that may interrupt an accurate determination of a touch input.

For example, in a case in which a touch input occurs due to overlapping between a predetermined first electrode 120 and the driving electrodes 1-2 through 1-7 to which a signal is applied, coordinates of the touch input may be calculated to be different from an actual location due to the mutual-capacitance recognition phenomenon generated between the first electrode 120 and the wiring pattern 150 connected to the driving electrodes 1-2 through 1-7.

To overcome the aforementioned phenomenon, a component acting as a noise signal may be eliminated by applying the recursive algorithm.

As described above, when a driving signal is applied through the driving electrode, that is, the second electrode 130, the touch sensing apparatus 100 may determine the touch input by acquiring the driving signal from the first electrode 120 corresponding to the driving signal.

That is, as illustrated in FIG. 1, in a case in which the wiring patterns 150 are symmetrically disposed based on the second axis that passes through each center of the plurality of first electrodes 120 extended from the first axis, when a touch input occurs in an area A of FIG. 1, a signal distribution acquirable by the controller chip 140 may be expressed in a two-dimensional (2D) matrix as shown in the following Table 1.

TABLE 1

| | driv- | driv- | driv- | driv- | driv- | driv- | driv- | driv- |
|---|---|---|---|---|---|---|---|---|
| | ing 1 | ing 2 | ing 3 | ing 4 | ing 5 | ing 6 | ing 7 | ing 8 |
| sensing 1 | 30 | 33 | 6 | 6 | 0 | 0 | 0 | 0 |
| sensing 2 | 0 | 0 | 0 | 0 | 0 | 0 | 0 | 0 |
| sensing 3 | 0 | 0 | 0 | 0 | 0 | 0 | 0 | 0 |
| sensing 4 | 0 | 0 | 0 | 0 | 0 | 0 | 0 | 0 |
| sensing 5 | 0 | 0 | 0 | 0 | 0 | 0 | 0 | 0 |
| sensing 6 | 0 | 0 | 0 | 0 | 0 | 0 | 0 | 0 |
| sensing 7 | 0 | 0 | 0 | 0 | 0 | 0 | 0 | 0 |

Referring to Table 1, in a case in which signals are sequentially acquired from driving electrodes 1-1 and 1-2 in response to a touch input A, a sensing electrode 1 may acquire signals having nearly similar strength. Even in a case in which signals are acquired from driving electrodes 1-3 and 1-4, sensing signals may be sensed by the sensing electrode 1 through a wiring that traverses over an area corresponding to the touch input A and thereby is connected to the driving electrode 1-3 and the driving electrode 1-4.

In the case of determining touch coordinates based on data of Table 1 without using a data correction process, a coordinate on the second axis, for example, an Y-axial direction of the touch input A may be accurately calculated. However, a coordinate on the first axis, for example, an X-axial direction may be calculated to lean toward the right side compared to an actual coordinate on the first axis, that is, the X-axial direction of the touch input A or may be recognized as multiple touches. Accordingly, a data processing process is provided for correction.

The controller chip 140 may subtract a value of a predetermined rate of each signal value from another signal value of a subsequent order based on orders in which the signals are acquired from the plurality of second electrodes 130.

The controller chip 140 may subtract the value of the predetermined rate of each signal value on the first axis from the other signal value of the subsequent order by the number of times M corresponding to the following Equation 1.

M=N−1 [Equation 1]

In Equation 1, N denotes the number of the plurality of second electrodes 130 disposed on the same first axis and M denotes an integer.

The rate may be within the range of 5% through 15%.

For example, according to an aspect of the present invention, data may be sequentially eliminated based on an order in which a signal is acquired from the second electrode 130.

That is, in Table 1, the controller chip 140 may subtract, from the other signal value of the subsequent order, each signal value sequentially acquired from the same sensing electrode.

According to an aspect of the present invention, in a case in which the second electrodes 130 are expressed as the driving electrodes 1-1 through 1-8 sequentially based on orders in which the signals are acquired, it is possible to apply a predetermined rate to a signal value of the driving electrode 1-1 and thereby subtract a value of the rate from each of signal values of the driving electrodes 1-2 through 1-8 that are other driving electrodes. A method of applying a predetermined rate to a signal value of the driving electrode 1-2 and thereby eliminating a value of the rate from each of signal values of the driving electrodes 1-3 through 1-8 may be repeated.

By applying the above recursive algorithm, it is possible to finally apply a predetermined rate to a signal value of the driving electrode 1-7 and thereby subtract a value of the rate from the signal value of the driving electrode 1-8. Accordingly, it is possible to subtract a predetermined value of a signal acquired on the same first axis from other signals values.

As described above, the wiring patterns 150 may be symmetrically disposed based on the second axis that passes through each center of the plurality of first electrodes 120 extended from the first axis.

That is, as illustrated in FIG. 1, the driving electrodes 1-1 through 1-4 may be connected to the wiring pattern 150 disposed along a left bezel region, and the driving electrodes 1-5 through 1-8 may be connected to the wiring pattern 150 disposed along a right bezel region.

According to the arrangement of the wiring patterns 150 in the structure of FIG. 1 and a connection relationship with driving electrodes, a process may be performed on the right side and the left side based on the driving electrodes 1-4 and 1-5, respectively.

In a case in which the number of the plurality of second electrodes 130 disposed on the same first axis is N and a direction in which a corresponding signal is acquired faces a symmetrical axis of the wiring pattern 150, the controller chip 140 may subtract the value of the predetermined rate of each signal value on the first axis from each of other signal values of subsequent orders by the number of times M corresponding to the following Equation 2.

M=N/2−1 [Equation 2]

In Equation 2, N denotes the number of the plurality of second electrodes 130 disposed on the first axis. When N is an even number, M may have an integer value. When N is an odd number, M may have an integer value through rounding off.

For example, as illustrated in FIG. 1, eight second electrodes 130 are disposed on the first axis and thus, a process of multiplying a predetermined rate to a signal value of a corresponding electrode, and subtracting a multiplication value from each of the signal values of the other second electrodes 130 on the first axis is performed a total of three times.

Hereinafter, a process of managing data by applying the recursive algorithm to the driving electrodes 1-1 through 1-4 according to an aspect of the present invention will be described.

In a case in which signals on the first axis including the driving electrodes 1-1 through 1-4 are acquired, it is possible to multiply a predetermined rate to a signal value of each driving electrode, and to subtract a multiplication value from each of the signal values of the other second electrodes 130 of subsequent orders on the first axis.

For example, referring to Table 1, when it is assumed that a first group of signal values sequentially acquired by the sensing electrode 1 through the respective driving electrodes 1-1 through 1-4 includes [30, 33, 6, 6] and a predetermined rate is 10%, it is possible to acquire ‘3’ by multiplying ‘0.1’ to the signal value ‘30’ of the driving electrode 1-1 among the signal values of the first group, and to subtract ‘3’ from each of the other signal values ‘33’, ‘6’, and ‘6’ of subsequent orders.

Here, referring to Table 1, signal values acquired by the sensing electrode 1 through the driving electrodes 1-5 through 1-8 and signal values acquired by other sensing electrodes are all zeros and thus, the result of applying the recursive algorithm may be identical to an actually acquired signal value.

Data acquired by performing a first calculation on sensing signals as above may be expressed as Table 2.

TABLE 2

| | driv- | driv- | driv- | driv- | driv- | driv- | driv- | driv- |
|---|---|---|---|---|---|---|---|---|
| | ing 1 | ing 2 | ing 3 | ing 4 | ing 5 | ing 6 | ing 7 | ing 8 |
| sensing 1 | 30 | 30 | 3 | 3 | 0 | 0 | 0 | 0 |
| sensing 2 | 0 | 0 | 0 | 0 | 0 | 0 | 0 | 0 |
| sensing 3 | 0 | 0 | 0 | 0 | 0 | 0 | 0 | 0 |
| sensing 4 | 0 | 0 | 0 | 0 | 0 | 0 | 0 | 0 |
| sensing 5 | 0 | 0 | 0 | 0 | 0 | 0 | 0 | 0 |
| sensing 6 | 0 | 0 | 0 | 0 | 0 | 0 | 0 | 0 |
| sensing 7 | 0 | 0 | 0 | 0 | 0 | 0 | 0 | 0 |

After applying a first algorithm to the driving electrode 1-1, a second algorithm is repeatedly applied to the driving electrode 1-2.

Referring to Table 2, when it is assumed that a second group of signal values sequentially acquired by the sensing electrode 1 through the respective driving electrodes 1-1 through 1-4 includes [30, 30, 3, 3] and a predetermined rate is 10%, it is possible to acquire ‘3’ by multiplying ‘0.1’ to the signal value ‘30’ of the driving electrode 1-2 among the signal values of the second group, and to subtract ‘3’ from each of the other signal values ‘3’ and ‘3’ of subsequent orders.

Data acquired by performing the second calculation on sensing signals as above may be expressed as Table 3.

TABLE 3

| | driv- | driv- | driv- | driv- | driv- | driv- | driv- | driv- |
|---|---|---|---|---|---|---|---|---|
| | ing 1 | ing 2 | ing 3 | ing 4 | ing 5 | ing 6 | ing 7 | ing 8 |
| sensing 1 | 30 | 30 | 0 | 0 | 0 | 0 | 0 | 0 |
| sensing 2 | 0 | 0 | 0 | 0 | 0 | 0 | 0 | 0 |
| sensing 3 | 0 | 0 | 0 | 0 | 0 | 0 | 0 | 0 |
| sensing 4 | 0 | 0 | 0 | 0 | 0 | 0 | 0 | 0 |
| sensing 5 | 0 | 0 | 0 | 0 | 0 | 0 | 0 | 0 |
| sensing 6 | 0 | 0 | 0 | 0 | 0 | 0 | 0 | 0 |
| sensing 7 | 0 | 0 | 0 | 0 | 0 | 0 | 0 | 0 |

After applying the second algorithm to the driving electrode 1-2, a third algorithm is repeatedly applied to the driving electrode 1-3.

Referring to Table 3, when it is assumed that a third group of signal values sequentially acquired by the sensing electrode 1 through the respective driving electrodes 1-1 through 1-4 includes [30, 30, 0, 0] and a predetermined rate is 10%, the signal value of the driving electrode 1-3 among the signal values of the third group is zero. Accordingly, the same value may be acquired even though subtraction is performed on all the signal values of the other driving electrodes.

Data acquired by performing the third calculation on sensing signals may be expressed as Table 4.

TABLE 4

| | driv- | driv- | driv- | driv- | driv- | driv- | driv- | driv- |
|---|---|---|---|---|---|---|---|---|
| | ing 1 | ing 2 | ing 3 | ing 4 | ing 5 | ing 6 | ing 7 | ing 8 |
| sensing 1 | 30 | 30 | 0 | 0 | 0 | 0 | 0 | 0 |
| sensing 2 | 0 | 0 | 0 | 0 | 0 | 0 | 0 | 0 |
| sensing 3 | 0 | 0 | 0 | 0 | 0 | 0 | 0 | 0 |
| sensing 4 | 0 | 0 | 0 | 0 | 0 | 0 | 0 | 0 |
| sensing 5 | 0 | 0 | 0 | 0 | 0 | 0 | 0 | 0 |
| sensing 6 | 0 | 0 | 0 | 0 | 0 | 0 | 0 | 0 |
| sensing 7 | 0 | 0 | 0 | 0 | 0 | 0 | 0 | 0 |

The recursive algorithm may be applied as above and thus, in a case in which a sensing signal is applied through a wiring that passes through the sensing region 160 to which a touch is not applied, such as the driving electrodes 1-3 and 1-4, a noise signal occurring in the sensing electrode 1 may be eliminated and thus, it is possible to more accurately determine a touch input.

According to an aspect of the present invention, coupling of mutual capacitance generated between the wiring pattern 150 and the first electrode 120 may be enforced by maximally decreasing a width between the wiring pattern 150 and the first electrode 120 in order to prevent the mutual capacitance from being easily changed by a contacting object such as a finger and the like.

A gap between a wiring connected to the second electrode 130 and the first electrode 120 may be set to be less than or equal to 1 μm.

FIG. 2 illustrates a configuration of a touch sensing apparatus according to an embodiment of the present invention.

According to another embodiment of the present invention, combinations, for example, arrangement and connection states of a plurality of first electrodes 220, a plurality of second electrodes 230, and a controller chip 240 formed on a substrate 210 may be identical to the configuration of FIG. 1. A wiring pattern 250 connected to each of the plurality of first electrodes 220 and the plurality of second electrodes 230 may be disposed to be different from the configuration of FIG. 1.

Even though the wiring patterns 250 are disposed as illustrated in FIG. 2, a touch sensing apparatus 200 may eliminate noise sensed in a sensing region 260 including the first electrode 220 by applying a recursive algorithm according to the present invention alike as described above.

In a case in which the wiring patterns 250 are disposed as illustrated in FIG. 2, when a touch input occurs in a region B of FIG. 2, a signal distribution acquirable by the controller chip 240 may be expressed in a 2D matrix as shown in Table 5.

TABLE 5

| | driv- | driv- | driv- | driv- | driv- | driv- | driv- | driv- |
|---|---|---|---|---|---|---|---|---|
| | ing 1 | ing 2 | ing 3 | ing 4 | ing 5 | ing 6 | ing 7 | ing 8 |
| sensing 1 | 30 | 33 | 6 | 0 | 0 | 0 | 0 | 0 |
| sensing 2 | 0 | 0 | 0 | 0 | 0 | 0 | 0 | 0 |
| sensing 3 | 0 | 0 | 0 | 0 | 0 | 0 | 0 | 0 |
| sensing 4 | 0 | 0 | 0 | 0 | 0 | 0 | 0 | 0 |
| sensing 5 | 0 | 0 | 0 | 0 | 0 | 0 | 0 | 0 |
| sensing 6 | 0 | 0 | 0 | 0 | 0 | 0 | 0 | 0 |
| sensing 7 | 0 | 0 | 0 | 0 | 0 | 0 | 0 | 0 |

The recursive algorithm according to the present invention may be applied. Here, in a case in which each of the signals on the first axis including a driving electrode 1-1 of FIG. 2 are acquired, it is possible to acquire a value by multiplying a predetermined rate to a signal value of a driving electrode and to subtract the acquired value from each of the signals value of the other second electrodes 230 on the first axis.

Referring to Table 5, when it is assumed that a first group of signal values sequentially acquired by the sensing electrode 1 through the respective driving electrodes 1-1 through 1-4 includes [30, 33, 6, 0] and a predetermined rate is 10%, it is possible to acquire ‘3’ by multiplying ‘0.1’ to the signal value ‘30’ of the driving electrode 1-1 among the signal values of the first group, and to subtract ‘3’ from each of the signal values ‘33’, 6’, and ‘0’ of subsequent orders.

Here, in a case in which a signal value acquired by subtracting a value of the predetermined rate of each signal value from another signal value is less than or equal to ‘0’, the controller chip 140 may recognize the signal value as ‘0’. Accordingly, the signal value of the driving electrode 1-4 is originally ‘-3’, but is recognized as ‘0’.

Data acquired by performing a first calculation on sensing signals as above may be expressed as Table 6.

TABLE 6

| | driv- | driv- | driv- | driv- | driv- | driv- | driv- | driv- |
|---|---|---|---|---|---|---|---|---|
| | ing 1 | ing 2 | ing 3 | ing 4 | ing 5 | ing 6 | ing 7 | ing 8 |
| sensing 1 | 30 | 30 | 3 | 0 | 0 | 0 | 0 | 0 |
| sensing 2 | 0 | 0 | 0 | 0 | 0 | 0 | 0 | 0 |
| sensing 3 | 0 | 0 | 0 | 0 | 0 | 0 | 0 | 0 |
| sensing 4 | 0 | 0 | 0 | 0 | 0 | 0 | 0 | 0 |
| sensing 5 | 0 | 0 | 0 | 0 | 0 | 0 | 0 | 0 |
| sensing 6 | 0 | 0 | 0 | 0 | 0 | 0 | 0 | 0 |
| sensing 7 | 0 | 0 | 0 | 0 | 0 | 0 | 0 | 0 |

After applying a first algorithm on the driving electrode 1-1, a second algorithm is repeatedly applied to the driving electrode 1-2.

Referring to Table 6, when it is assumed that a second group of signal values sequentially acquired by the sensing electrode 1 through the respective driving electrodes 1-1 through 1-4 includes [30, 30, 3, 0] and a predetermined rate is 10%, it is possible to acquire ‘3’ by multiplying ‘0.1’ to the signal value ‘30’ of the driving electrode 1-2 among the signal values of the second group and to subtract ‘3’ from each of the other signal values ‘3’ and ‘0’ of subsequent orders.

Data acquired by performing a second calculation on sensing signals as above may be expressed as Table 7.

TABLE 7

| | driv- | driv- | driv- | driv- | driv- | driv- | driv- | driv- |
|---|---|---|---|---|---|---|---|---|
| | ing 1 | ing 2 | ing 3 | ing 4 | ing 5 | ing 6 | ing 7 | ing 8 |
| sensing 1 | 30 | 30 | 0 | 0 | 0 | 0 | 0 | 0 |
| sensing 2 | 0 | 0 | 0 | 0 | 0 | 0 | 0 | 0 |
| sensing 3 | 0 | 0 | 0 | 0 | 0 | 0 | 0 | 0 |
| sensing 4 | 0 | 0 | 0 | 0 | 0 | 0 | 0 | 0 |
| sensing 5 | 0 | 0 | 0 | 0 | 0 | 0 | 0 | 0 |
| sensing 6 | 0 | 0 | 0 | 0 | 0 | 0 | 0 | 0 |
| sensing 7 | 0 | 0 | 0 | 0 | 0 | 0 | 0 | 0 |

After applying the second algorithm on the driving electrode 1-2, a third algorithm is repeatedly applied to the driving electrode 1-3.

Referring to Table 7, when it is assumed that a third group of signal values sequentially acquired by the sensing electrode 1 through the respective driving electrodes 1-1 through 1-4 includes [30, 30, 0, 0] and a predetermined rate is 10%, the signal value of the driving electrode 3 among the signal values of the third group is zero. Accordingly, the same value may be acquired even though subtraction is performed on all the signal values of other driving electrodes.

Data acquired by performing a third calculation on sensing signals may be expressed as Table 8.

TABLE 8

| | driv- | driv- | driv- | driv- | driv- | driv- | driv- | driv- |
|---|---|---|---|---|---|---|---|---|
| | ing 1 | ing 2 | ing 3 | ing 4 | ing 5 | ing 6 | ing 7 | ing 8 |
| sensing 1 | 30 | 30 | 0 | 0 | 0 | 0 | 0 | 0 |
| sensing 2 | 0 | 0 | 0 | 0 | 0 | 0 | 0 | 0 |
| sensing 3 | 0 | 0 | 0 | 0 | 0 | 0 | 0 | 0 |
| sensing 4 | 0 | 0 | 0 | 0 | 0 | 0 | 0 | 0 |
| sensing 5 | 0 | 0 | 0 | 0 | 0 | 0 | 0 | 0 |
| sensing 6 | 0 | 0 | 0 | 0 | 0 | 0 | 0 | 0 |
| sensing 7 | 0 | 0 | 0 | 0 | 0 | 0 | 0 | 0 |

The controller chips 140 and 240 of the present invention may acquire sensing signals in which a noise component is eliminated by applying the recursive algorithm as above, and may determine the touch input based on a change in mutual capacitance that is generated between the plurality of first electrodes 120 and 220 and the plurality of second electrodes 130 and 230 using the acquired sensing signal.

FIG. 3 is a diagram illustrating an example of recognizing multiple touches using a touch sensing apparatus according to still another embodiment of the present invention.

Referring to still another embodiment of the present invention, even though multiple touches occur in a touch region C and a touch region D as illustrated in FIG. 3, it is possible to eliminate noise sensed by a first electrode 320 that is a sensing electrode by applying a recursive algorithm according to the present invention alike as described above.

That is, as illustrated in FIG. 3, in a case in which wiring patterns 350 are symmetrically disposed based on a second axis that passes through each center of a plurality of first electrodes 320 extended from a first axis on a substrate 310 and the multiple touches occur in the touch region C and the touch region D of FIG. 3, a signal distribution acquirable by a controller chip 340 may be expressed as a 2D matrix as shown in the following Table 9.

TABLE 9

| | driv- | driv- | driv- | driv- | driv- | driv- | driv- | driv- |
|---|---|---|---|---|---|---|---|---|
| | ing 1 | ing 2 | ing 3 | ing 4 | ing 5 | ing 6 | ing 7 | ing 8 |
| sensing 1 | 30 | 33 | 6 | 0 | 0 | 0 | 0 | 0 |
| sensing 2 | 0 | 0 | 0 | 0 | 0 | 0 | 0 | 0 |
| sensing 3 | 30 | 33 | 6 | 0 | 0 | 0 | 0 | 0 |
| sensing 4 | 0 | 0 | 0 | 0 | 0 | 0 | 0 | 0 |
| sensing 5 | 0 | 0 | 0 | 0 | 0 | 0 | 0 | 0 |
| sensing 6 | 0 | 0 | 0 | 0 | 0 | 0 | 0 | 0 |
| sensing 7 | 0 | 0 | 0 | 0 | 0 | 0 | 0 | 0 |

Referring to FIG. 3, the recursive algorithm according to the present invention may be applied to a sensing electrode 1 and a sensing electrode 3 to which sensing signals are applied by the multiple touches, respectively. Accordingly, the recursive algorithm may be applied to each of a sensing region 360 corresponding to the sensing electrode 1 and a sensing region 370 corresponding to the sensing electrode 3.

That is, referring to FIG. 3, it is possible to acquire a value by multiplying a predetermined rate to each of signal values of the driving electrodes 1-1 through 1-4 with respect to the sensing region 360, and to subtract the acquired value from each of the signal values of other second electrodes 330 of subsequent orders on the first axis on the sensing region 360.

Also, it is possible to acquire a value by multiplying a predetermined rate to each of signal values of the driving electrode 3-1 through 3-4 on the sensing region 370 and to subtract the acquired value from each of the signal values of other second electrodes 330 on the first axis on the sensing region 370.

The following algorithm performing process may be sequentially performed with respect to the respective sensing regions 360 and 370 as described above, and final data may be expressed as the following Table 10.

TABLE 10

| | driv- | driv- | driv- | driv- | driv- | driv- | driv- | driv- |
|---|---|---|---|---|---|---|---|---|
| | ing 1 | ing 2 | ing 3 | ing 4 | ing 5 | ing 6 | ing 7 | ing 8 |
| sensing 1 | 30 | 30 | 0 | 0 | 0 | 0 | 0 | 0 |
| sensing 2 | 0 | 0 | 0 | 0 | 0 | 0 | 0 | 0 |
| sensing 3 | 30 | 30 | 0 | 0 | 0 | 0 | 0 | 0 |
| sensing 4 | 0 | 0 | 0 | 0 | 0 | 0 | 0 | 0 |
| sensing 5 | 0 | 0 | 0 | 0 | 0 | 0 | 0 | 0 |
| sensing 6 | 0 | 0 | 0 | 0 | 0 | 0 | 0 | 0 |
| sensing 7 | 0 | 0 | 0 | 0 | 0 | 0 | 0 | 0 |

Hereinafter, a touch sensing method using a touch sensing apparatus according to an embodiment of the present invention will be described.

FIG. 4 is a flowchart illustrating a touch sensing method according to an embodiment of the present invention.

Referring to FIG. 4, in operation 410, the touch sensing apparatus 100 according to an embodiment of the present invention may acquire a signal from each of the plurality of first electrodes 120 and the plurality of second electrodes 130 formed on one surface of the substrate 110.

In operation 420, the touch sensing apparatus 100 may subtract a value of a predetermined rate of each signal value from each of the other signal values of subsequent orders based on orders in which the signals are acquired.

In operation 430, the touch sensing apparatus 100 may determine a touch input based on the signal.

According to an embodiment of the present invention, a process of sequentially subtracting the value of the predetermined rate of each signal value from each of the other signal values based on the same direction as the orders in which the signals are acquired from the plurality of second electrodes 130 in operation 430.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. An apparatus for sensing a touch, comprising:
a substrate;
a plurality of first electrodes formed on the substrate;
a plurality of second electrodes formed on the substrate; and
a controller chip configured to acquire signals from the plurality of first electrodes and the plurality of second electrodes, and to determine a touch input,
wherein the controller chip subtracts a value of a predetermined rate of each signal value from another signal value.

2. The apparatus of claim 1, wherein the plurality of first electrodes and the plurality of second electrodes are disposed on the same surface of the substrate.

3. The apparatus of claim 1, wherein the plurality of first electrodes is sensing electrodes and the plurality of second electrodes is driving electrodes electrically separate from the plurality of first electrodes.

4. The apparatus of claim 3, wherein the controller chip subtracts the value of the predetermined rate of each signal value from another signal value of a subsequent order based on orders in which the signals are acquired from the plurality of second electrodes.

5. The apparatus of claim 4, wherein when a value acquired by subtracting the value of the predetermined rate of each signal value from the other signal value of the subsequent order is less than or equal to ‘0’, the controller chip recognizes the signal value as ‘0’.

6. The apparatus of claim 5, wherein each of the plurality of first electrodes is disposed in a shape of a sensing bar that is extended along a first axis, and each of the plurality of second electrodes is disposed on a second axis that intersects the first axis.

7. The apparatus of claim 6, further comprising:
a wiring pattern configured to electrically connect the plurality of second electrodes and the controller chip,
wherein, among the plurality of second electrodes, electrodes disposed on the same second axis are electrically connected to each other through the wiring pattern.

8. The apparatus of claim 7, wherein the wiring patterns are symmetrically disposed based on the second axis that passes through each center of the plurality of first electrodes extended from the first axis.

9. The apparatus of claim 6, wherein the controller chip subtracts the value of the predetermined rate of each signal value on the first axis from the other signal value of the subsequent order by the number of times M corresponding to the following Equation 1:
M=N−1 [Equation 1]
where N denotes the number of the plurality of second electrodes disposed on the same first axis and M denotes an integer.

10. The apparatus of claim 6, wherein the controller chip subtracts the value of the predetermined rate of each signal value on the first axis from the other signal value of the subsequent order by the number of times M corresponding to the following Equation 2:
M=N/2−1 [Equation 2]
where N denotes the number of the plurality of second electrodes disposed in the same second axial direction and M denotes an integer.

11. The apparatus of claim 6, further comprising:
a plurality of ground wirings formed along the first axis on the substrate on or below at least one first electrode.

12. The apparatus of claim 5, wherein the substrate is provided as a transparent window, and
the plurality of first electrodes, the plurality of second electrodes, and an wiring pattern are integrally formed with the transparent window.

13. The apparatus of claim 11, wherein the plurality of ground wirings is spaced apart from the plurality of first electrodes to thereby be electrically insulated from each other and be electrically connected to a ground of the substrate.

14. The apparatus of claim 1, wherein the plurality of second electrodes is disposed on the substrate to be in a patch form.

15. The apparatus of claim 1, wherein the rate is within the range of 5% to 15%.

16. The apparatus of claim 1, wherein the controller chip determines the touch input based on a change in mutual-capacitance generated between the plurality of first electrodes and the plurality of second electrodes.

17. The apparatus of claim 16, wherein the controller chip determines the touch input by applying signals to at least a portion of the plurality of second electrodes and by acquiring the signals from the plurality of first electrodes.

18. A method of sensing a touch, the method comprising:
acquiring signals from a plurality of first electrodes and a plurality of second electrodes formed on one surface of a substrate; and
determining a touch input based on the signals,
wherein the determining of the touch input comprises subtracting a value of a predetermined rate of each signal value from another signal value of a subsequent order based on orders in which the signals are acquired.

19. The method of claim 18, wherein the determining of the touch input further comprises subtracting the value of the predetermined rate of each signal value from the other signal value of the subsequent order based on orders in which the signals are acquired from the plurality of second electrodes.

20. The method of claim 19, wherein the plurality of first electrodes is extended from a first axis and the plurality of second electrodes is disposed on a second axis that intersects the first axis.

21. The method of claim 20, wherein in a case in which a wiring patterns configured to electrically connect the plurality of second electrodes and a controller chip for determining the touch input are symmetrically disposed based on the second axis that passes through each center of the plurality of first electrodes extended from the first axis, the determining of the touch input further comprises subtracting the value of the predetermined rate of each signal value on the first axis from the other signal value of the subsequent order by the number of times M corresponding to the following Equation 2 when the number of the plurality of second electrodes disposed on the same first axis is N and a direction corresponding to an order in which a corresponding signal is acquired faces a symmetrical axis of the wiring pattern:
M=N/2−1 [Equation 2]
where M denotes an integer.

22. The method of claim 18, wherein at least a portion of the plurality of second electrodes is electrically connected to another plurality of second electrodes disposed on the same second axis.
